(19) United States
(12) Patent Application Publication
(10) Pub. No.: US 2012/0304516 A1
(43) Pub. Date: Dec. 6, 2012

(54) SUPPORT MECHANISM WITH MOUNTING MEMBER ROTATINGLY RECEIVED IN SUPPORT SEAT

(75) Inventor: ZHEN-YU YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/337,174

(22) Filed: Dec. 26, 2011

(30) Foreign Application Priority Data
May 30, 2011 (CN) 201110142253.9

(51) Int. Cl. G09F 15/00

(52) U.S. Cl. 40/606.01

(57) ABSTRACT

A support mechanism includes a hinge assembly, a hollow support seat, a positioning member and a mounting member. The support seat includes a plurality of restricting portions and a plurality of support portions corresponding to the restricting portions, the restricting portions and the support portions cooperatively defining a receiving space therebetween. The support seat further defines a positioning hole in the circumferential wall thereof, the positioning hole communicating with the receiving space. The positioning member is received in the positioning hole. The mounting member is connected to the hinge assembly and includes a peripheral position portion, the position portion is capable of passing the restricting portions when inserted into the support seat and rotating within the receiving space to a predetermined position in which the positioning member is engagable with the position portion of the mounting member to fix the hinge assembly to the support seat.

### BACKGROUND

1. Technical Field

The present disclosure relates to support mechanisms, and more particularly, to a support mechanism used for supporting a display panel.

2. Description of Related Art

A commonly used display device includes a display panel, a base seat and a support mechanism. The display panel connects with the base seat via the support mechanism, and the display panel is able to be viewed from many different angles by adjusting its position. The support mechanism generally includes a support seat, a mounting member, and a hinge assembly connected to the mounting member. The base seat may be fixed to a desk or a wall in a room, and the support seat is fixed to the base seat. The mounting member defines two positioning holes and a plurality of through holes. The support seat includes two positioning posts and defines a plurality of screw holes. The two positioning posts extend into the two positioning holes, and the screw holes are aligned with the through holes. Then a plurality of screws is received in the through holes and the screw holes such that the mounting member is fixed to the support seat. Typically, the support mechanism defines many screw holes and the two positioning holes, and requires many screws for assembly. This makes the assembly of the support mechanism complicated.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, side plan view of an embodiment of a support mechanism.

FIG. 2 is an exploded, isometric view of the support mechanism of FIG. 1.

FIG. 3 is similar to FIG. 2, but viewed from another aspect.

FIG. 4 is an assembled, isometric view of a portion of the support mechanism of FIG. 2.

FIG. 5 is an exploded view of the portion of the support mechanism shown in FIG. 4.

FIG. 6 is another exploded view of the portion of the support mechanism shown in FIG. 4, viewed from a bottom thereof.

FIG. 7 is similar to FIG. 5, but shows a portion of an alternative embodiment of a support mechanism.

### DETAILED DESCRIPTION

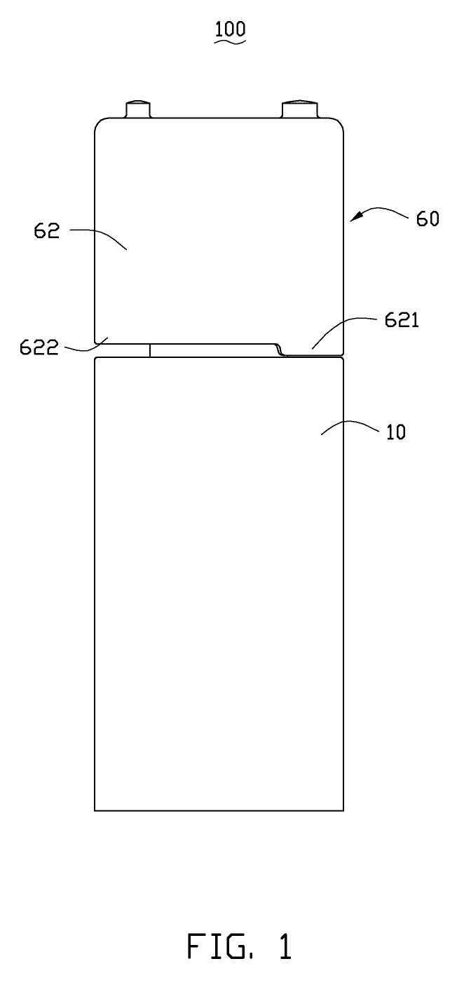

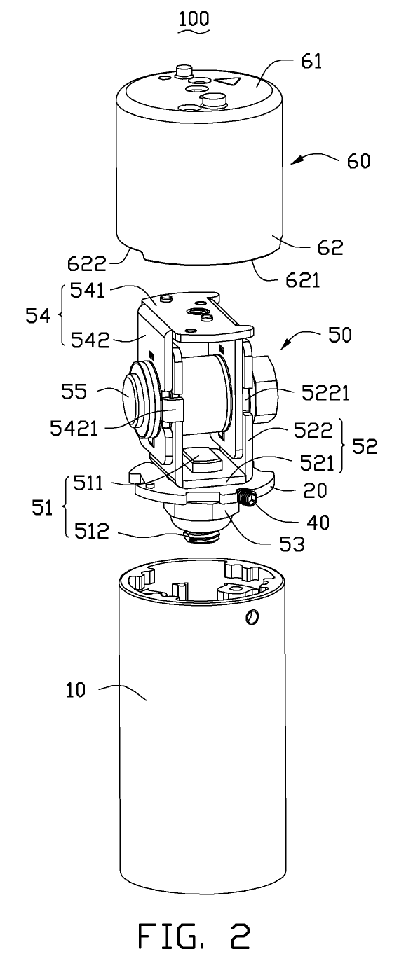

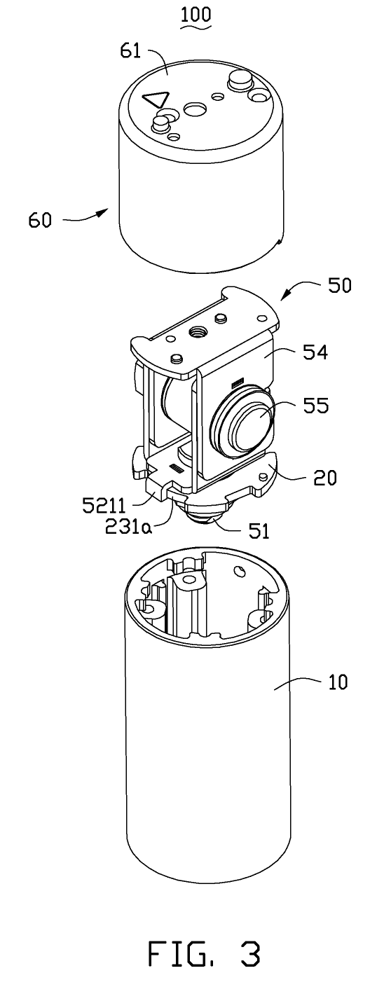

Referring to FIGS. 1-3 and 5, an embodiment of a support mechanism 100 includes a support seat 10, a mounting member 20, a fixing member 30, a positioning member 40, a hinge assembly 50, and a connecting sleeve 60. The support seat 10 includes a mounting end 11 and a fixing end 12 opposite to the mounting end 11. The mounting member 20 is fixed to the mounting end 11 of the support seat 10 by the positioning member 40. The fixing member 30 is connected to the fixing end 12 of the support seat 10. The hinge assembly 50 is connected to the mounting member 20. The connecting sleeve 60 is sleeved on the hinge assembly 50. In the present embodiment, the support mechanism 100 is used for a flat screen television. The connecting sleeve 60 is connected to a display panel of the flat screen television, and the fixing member 30 is fixed to a base of the flat screen television. The support mechanism 100 allows the position of the display panel to be adjusted so that the display panel is able to be viewed from many different angles.

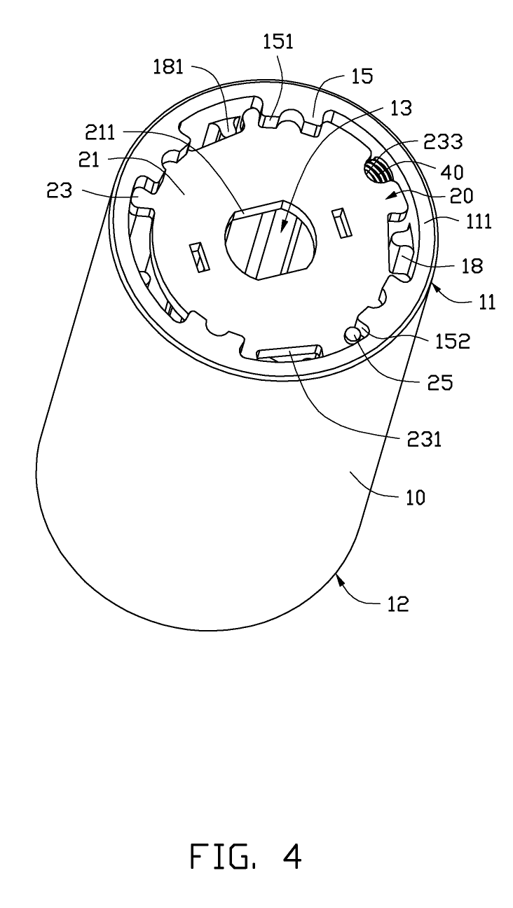

Referring also to FIG. 4, the support seat 10 is substantially a cylindrical shell made of extruded aluminum material. The mounting end 11 of the support seat 10 includes a mounting surface 111. The fixing end 12 of the support seat 10 includes a fixing surface 121 parallel to the mounting surface 111.

The support seat 10 defines a chamber 13 along an axial direction thereof. A plurality of restricting portions 15 is arranged on an inner wall of the support seat 10 in the chamber 13, at the mounting end 11. A plurality of elongate support portions 16 is arranged on the inner wall of the support seat 10, corresponding to the restricting portions 15. A plurality of elongate support bars 18 is arranged on the inner wall of the support seat 10, corresponding to and spaced a short distance from the support portions 16, respectively.

The restricting portions 15 are arranged around the inner periphery of the inner wall of the support seat 10 at the mounting end 11, and are spaced from each other. Each restricting portion 15 includes an inner side surface 151 parallel to the axis of the support seat 10. One of the restricting portions 15 further includes a restricting surface 152 adjacent to the inner side surface 151 thereof.

The support portions 16 are parallel to and spaced from each other, and are arranged on the inner wall of the support seat 10 in the chamber 13. Each support portion 16 is a substantially elongated protrusion extending from near the mounting end 11 toward the fixing end 12, and has a support surface 161 at an end thereof facing the corresponding restricting portion 15. The support surface 161 extends along a radial direction of the support seat 10, and has a radial length greater than that of the corresponding restricting portion 15. Thus the support surfaces 161 of all the support portions 16 cooperatively provide a discontinuous supporting shelf inside a top portion of the chamber 13. The discontinuous supporting shelf enables the mounting member 20 to be received in the top portion of the chamber 13 and supported on the discontinuous supporting shelf. Each support portion 16 defines an elongate mounting hole 163 parallel to the axial direction of the support seat 10. The mounting hole 163 extends from the support surface 161 to an end of the support portion 16 opposite to the support surface 161.

The support portions 16 and the restricting portions 15 cooperatively define a receiving space 17 therebetween, for receiving the mounting member 20. The receiving space 17 is substantially in the form of an annulus; i.e., washer-shaped. The support seat 10 further defines a positioning hole 171 in the side wall thereof. The positioning hole 171 perpendicularly extends through the side wall and communicates with the receiving space 17. In the embodiment, the positioning hole 171 is a screw hole engagingly receiving the positioning member 40.

The support bars 18 are arranged around the periphery of the chamber 13, parallel to the support portions 16. Each support bar 18 is located between two support portions 16, and includes a support end 181 facing the receiving space 17. The support bars 18, the support portions 16 and the inner wall of the support seat 10 cooperatively form a step surface 183 at the fixing end 12 of the support seat 10, the step surface 183 being parallel to the fixing surface 121. The step surface 183 is a generally annular surface, and is located at an inner side of the fixing surface 121. The mounting holes 163 of the support portions 16 extend though to the step surface 183.

The mounting member 20 has an irregular plate shape, and includes a central main body 21, a position portion 23 at a circumferential periphery of the main body 21, and a position protrusion 25 located on the position portion 23.

The main body 21 has a plate shape, and defines a mounting hole 211 in a middle portion thereof. The mounting hole 211 is provided for mounting of the hinge assembly 50 on the main body 21.

The position portion 23 defines a plurality of notches 231 around a periphery thereof, and a position groove 233 in the periphery thereof. The notches 231 correspond to the restricting portions 15, respectively. Each notch 231 is bounded on an inner side by a side surface 2311. The side surface 2311 is arc shaped. Opposite ends of the side surface 2311 are smoothly connected to the periphery of the position portion 23 via two short connecting surfaces (not labeled), respectively. A length of each notch 231 is greater than a corresponding length of the respective restricting portion 15. The side surface 2311 of the notch 231 and the inner side surface 151 of the corresponding restricting portion 15 can cooperatively define a narrow gap therebetween. The gaps enable the position portion 23 to extend into the receiving space 17 smoothly in assembly. In addition, one of the notches 231 is longer than the other notches 231, and is designated herein as a long notch 231a. The position groove 233 is a recess in the periphery of the position portion 23. In the embodiment, the position groove 233 is an approximately semicircular cutout.

The position protrusion 25 extends from the position portion 23 along a direction substantially perpendicular to the main body 21. The position protrusion 25 is located adjacent to one of the notches 231. In the embodiment, the position protrusion 25 is a substantially cylindrical short post or stud.

The fixing member 30 is a substantially circular plate fixed to the step surface 183 of the support seat 10. The fixing member 30 defines a plurality of screw holes 31 corresponding to the mounting holes 163 of the support portion 16.

The positioning member 40 is in the shape of an externally threaded cylinder or rod. The positioning member 40 includes a resisting end 41 corresponding to the position groove 233, and an engaging portion 43 corresponding to the positioning hole 171.

Referring to FIGS. 1 through 3 again, the hinge assembly 50 includes a support rod 51 extending through the mounting hole 211, a bracket 52 mounted on the support rod 51, a fastener 53 for fixing an end of the support rod 51, a rotation member 54, and a pivot member 55 used for rotatably connecting the bracket 52 and the rotation member 54.

The support rod 51 includes a connecting end 511 non-rotatably connected to the bracket 52, and a screw portion 512 below the connecting end 511.

The bracket 52 is generally U-shaped, and includes a base 521 and a pair of support plates 522 extending perpendicularly up from opposite ends of the base 521. The base 521 defines a connecting hole (not labeled) corresponding to the mounting hole 211, and includes a blocking portion 5211. The blocking portion 5211 is located on a bottom side of the base 521, and engages in the long notch 231a. The blocking portion is capable of resisting the restricting portions 15 at opposite ends of the long notch 231, to restrict a rotation angle between the bracket 52 and the mounting member 20. The two support plates 522 respectively include two recesses 5221 at a same side.

The fastener 53 is a nut, and is capable of engaging with the screw portion 512 of the support rod 51 to clamp the mounting member 20 and the base 521 of the bracket 52 between the connecting end 511 and the fastener 53.

The rotation member 54 is similar to the bracket 52. The rotation member 54 is generally U-shaped, but has an inverted orientation relative to the bracket 52. Thus the rotation member 54 can be considered to be generally symmetrically positioned relative to the bracket 52. The rotation member 54 includes a base 541 and a pair of support plates 542. The base 541 defines a first screw hole (not labeled), for mounting of the display panel on the base 541. One support plate 542 further includes a latching portion 5421 capable of engaging in one recess 5221. The latching portion 5421 is capable of sliding up or down along the recess 5221 and resisting opposite end surfaces of the recess 5221. The sliding is along a circular arc path, wherein the sliding up is in a counterclockwise direction and the sliding down is in a clockwise direction. Thus, the movable engagement of the latching portion 5421 in the recess 5221 restricts a rotation angle between the rotation member 54 and the bracket 52. In a typical embodiment, the rotation angle is about 7°.

The pivot member 55 extends into the support plates 522 of the bracket 52 and the support plates 542 of the rotation member 54 so that the rotation member 54 is rotatably connected to the bracket 52.

The connecting sleeve 60 is a substantially cylindrical shell made of extruded aluminum material. The connecting sleeve 60 includes a top plate 61, and a cylindrical support wall 62 extending perpendicularly down from the periphery of the top plate 61. The top plate 61 defines a second screw hole (not labeled) corresponding to the first screw hole of the hinge assembly 50. A bottom end of the support wall 62 includes an arc-shaped joint portion 621, and an arc-shaped notch portion 622 adjacent to the joint portion 621. In the illustrated embodiment, the joint portion 621 is smaller than a semicircular arc, the notch portion 622 is greater than a semicircular arc, and the joint portion 621 and the notch portion 622 cooperatively form the entire bottom end of the support wall 62. The joint portion 621 abuts the mounting end 11 of the support seat 10. The notch portion 622 and the mounting end 11 cooperatively define a narrow arc-shaped gap therebetween, to enable the connecting sleeve 60 and the rotation member 54 to rotate in unison around the pivot member 55 relative to the support seat 10 within a predetermined angle. In the typical embodiment, the predetermined angle is about 7°, and corresponds to the above-described rotation angle between the rotation member 54 and the bracket 52.

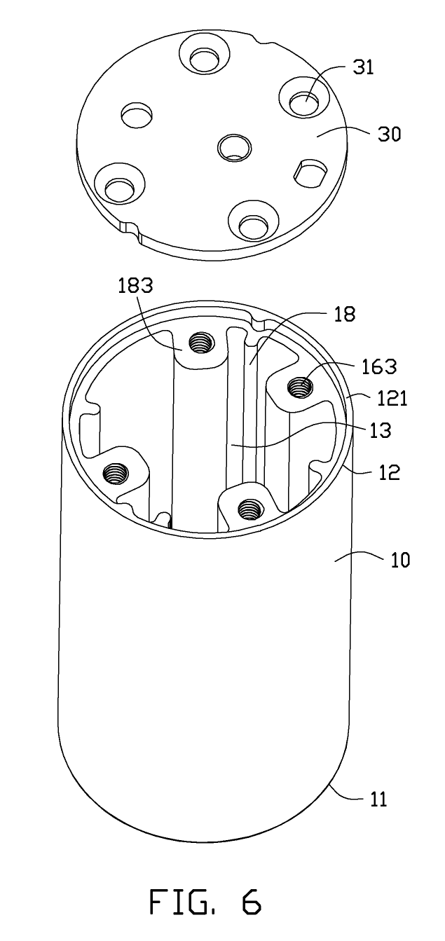

Referring to FIGS. 1 through 6, in assembly, the mounting member 20 abuts against the base 521 of the bracket 52, and the blocking portion 5211 of the base 521 is latched in the long notch 231 a of the mounting member 20. The support rod 51 extends into the connecting hole of the base 521 and the mounting hole 211 of the mounting member 20. The fastener 53 engages with the screw portion 512 to clamp the mounting member 20 and the base 521 of the bracket 52 between the connecting end 511 and the fastener 53. Broadly speaking, the rotation member 54 and the bracket 52 are symmetrically oriented relative to each other. The support plates 542, 522 are parallel to each other. The latching portion 5421 engages in said one recess 5221. The pivot member 55 extends into the support plates 542, 522 to rotatably connect the rotation member 54 to the bracket 52. The connecting sleeve 60 sleeves on the hinge assembly 50. The second screw hole of the connecting sleeve 60 is aligned with the first screw hole of the base 541 of the rotation member 54, and the notch portion 622 is aligned with the blocking portion of the base 521. A fastener (not shown) engages into the first and second screw holes to fix the display panel to the top plate 61. By such engagement, the connecting sleeve 60 and the hinge assembly 50 are attached together.

The fixing member 30 abuts against the step surface 183. The fixing member 30 is fixed to the support seat 10 by bolts (not shown) extending through the screw holes 31 and engaging in the mounting holes 163. The fixing member 30 is also configured to be fixed to an object, such as the base of the flat screen television.

The joint portion 621 of the connecting sleeve 60 is aligned with the mounting surface 111 of the support seat 10. The notches 231 are aligned with the restricting portions 15, and then the mounting member 20 is extended into the chamber 13 toward the fixing end 12 until the position portion 23 abuts against the support surfaces 161 of the restricting portions 16 and the support ends 181 of the support bars 18. The position portion 23 is thus movably received in the receiving space 17.

Then the position portion 23 is rotated around the axis of the support seat 10, and the position protrusion 25 correspondingly rotates until the position protrusion 25 reaches the restricting surface 152 and stops. At such position, the position groove 233 is aligned with the positioning hole 171. The positioning member 40 extends into the positioning hole 171, with the engaging portion 43 engaging in the positioning hole 171. The resisting end 41 abuts against and resists an inmost edge of the position portion 23 in the position groove 233, to thereby fix the mounting member 20 to the support seat 10. Thus, the assembly of the support mechanism 100 is completed.

When adjusting the pitch angle of the display panel, a force is applied to the display panel, and the display panel drives the connecting sleeve 60 and the rotation member 54 to rotate relative to the bracket 52. Because of the gap between the notch portion 622 of the connecting sleeve 60 and the mounting end 11 of the support seat 10, the connecting sleeve 60 is capable of swinging relative the support seat 10, such that the pitch angle of the display panel is adjustable. At the same time, the gap restricts the pitch angle of the display panel to a certain range. Furthermore, the latching portion 5421 of the rotation member 54 slides in the recess 5221 and is restricted by the opposite end surfaces of the recess 5221 to also correspondingly restrict the pitch angle of the display panel. In the typical embodiment, the pitch angle is about 7 degrees.

In summary, in the support mechanism 100, the position portion 23 of the mounting member 20 extends into the receiving space 17 and rotates to a predetermined position in the receiving space 17. The protrusion 25 thereby abuts the restricting surface 152 of the restricting portion 15 to prevent over-rotation of the position portion 23. The positioning member 40 extends into the positioning hole 171 and resists the inmost edge of the position portion 23 in the position groove 233, such that the mounting member 20 with the display panel are securely fixed to the support seat 10. Therefore, in a typical application where the base of the flat screen television is permanently fixed to an object such as a wall or a ceiling in a room and the support seat 10 is fixed to the base, the display panel can be assembled to and disassembled from the support seat 10 quickly and easily. This is highly advantageous when, e.g., the display panel needs maintenance. In addition, once the display panel is assembled to the support seat 10, a pitch angle of the display panel can be adjusted conveniently. Furthermore, the support seat 10 and the connecting sleeve 60 are made of extruded aluminum materials. Thus the support seat 10 and the connecting sleeve 60 can be disposed outside the support mechanism 100 and provide the support mechanism 100 with a good aesthetic appearance.

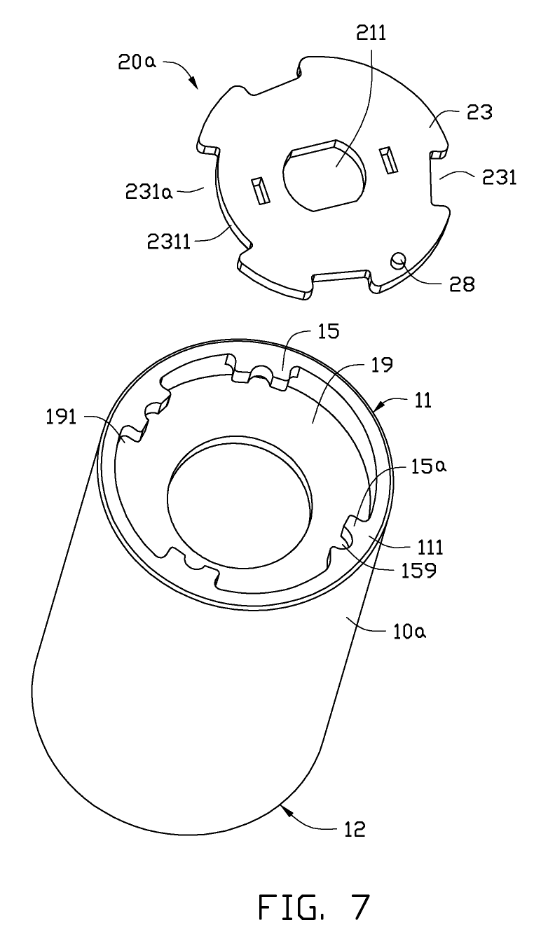

Referring to FIG. 7, in an alternative embodiment, a support seat 10a and a mounting member 20a can be configured as follows. The plurality of support portions 16 described above may instead be a single annular (or cylindrical) protrusion 19, with a top end of the protrusion 19 corresponding to three restricting portions 15 and one restricting portion 15a. In such case, the top end of the protrusion 19 and the restricting portions 15, 15a cooperatively define a receiving space 191 therebetween, similar to the above-described receiving space 17.

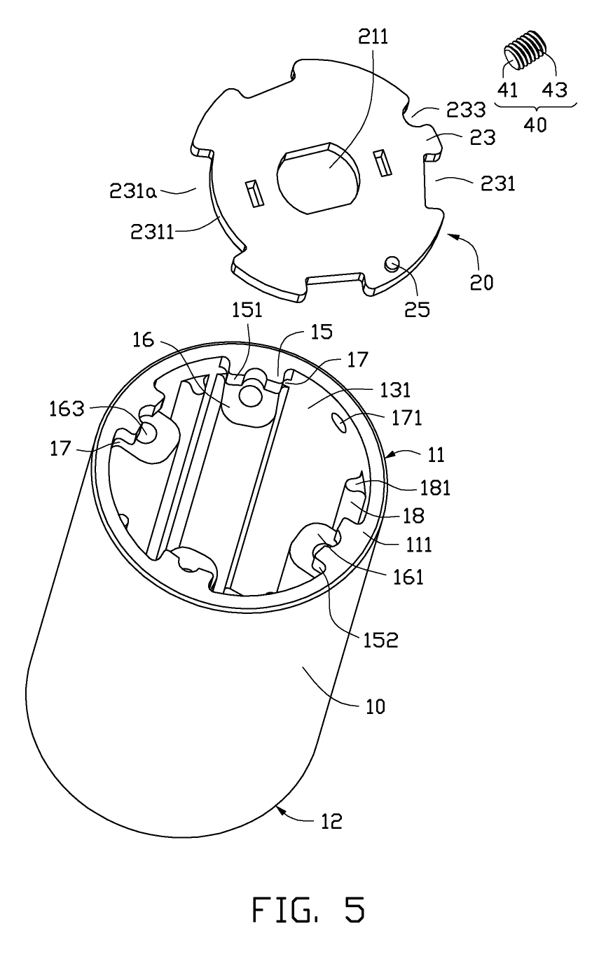

The position protrusion 25 described above may instead be a resilient latching member 28 fixed on the mounting member 20a, and the restricting portion 15a may have a latching groove 159 defined therein. In such case, when the position portion 23 is rotated around the axis of the support seat 10a, the resilient latching member 28 resiliently rides over an end of the restricting portion 15a and then engages in the latching groove 159, to thereby secure the mounting member 20a in position relative to the support seat 10a. Furthermore, in such case, the positioning member 40, positioning hole 171 and position groove 233 (see FIG. 5) can optionally be omitted.

Finally, while various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A support mechanism, comprising:
a hinge assembly for being connected to a display panel;
a hollow support seat;
an inner face of a circumferential wall of the support seat comprising:
a plurality of restricting portions aligned in a plane perpendicular to an axis of the support seat; and
a plurality of support portions corresponding to the restricting portions;
the restricting portions and top ends of the support portions cooperatively defining a receiving space therebetween; and
the support seat further defining a positioning hole in the circumferential wall thereof, the positioning hole communicating with the receiving space;
a positioning member received in the positioning hole; and
a mounting member connected to the hinge assembly and comprising a peripheral position portion, the position portion being capable of passing the restricting portions when inserted into a top of the support seat and rotating within the receiving space to a predetermined position in which the positioning member is engagable with the position portion of the mounting member to fix the hinge assembly to the support seat.

2. The support mechanism of claim 1, wherein the position portion comprises a position protrusion, and when the position portion is rotated to the predetermined position, the position protrusion abuts one of the restricting portions to locate the mounting member in the support seat.

3. The support mechanism of claim 1, wherein each support portion comprises a support surface facing the restricting portion, and the support surface extends along a radial direction of the support seat.

4. The support mechanism of claim 1, wherein the position portion further defines a position groove, the positioning member is in the shape of an externally threaded cylinder and comprises a resisting end, and the resisting end extends into and is engaged in the position groove.

5. The support mechanism of claim 4, wherein the position portion defines a plurality of notches around a periphery thereof, the plurality of notches correspond to the plurality of restricting portions, and a length of each notch is greater than that of the corresponding restricting portion, such that an inner wall of each notch and the corresponding restricting portion cooperatively define a gap therebetween to enable the position portion to pass the restricting portions when inserted into the top of the support seat and reach the receiving space.

6. The support mechanism of claim 5, wherein the hinge assembly comprises a bracket and a rotation member, a first end of the rotation member is rotatably connected to the bracket, a second end of the rotation member opposite to the first end is configured for being connected to a display panel, the bracket comprises a blocking portion, and the plurality of notches of the position portion comprise a long notch; and when the position portion is rotated within the receiving space, the blocking portion is capable of resisting opposite ends of the long notch to restrict a rotation angle between the bracket and the mounting member.

7. The support mechanism of claim 6, wherein the bracket defines a recess, the rotation member comprises a latching portion, and the latching portion is slidably engaged in the recess and capable of resisting opposite end surfaces of the recess to restrict a rotation angle between the rotation member and the bracket.

8. The support mechanism of claim 7, further comprising a connecting sleeve sleeved on the hinge assembly and connected to the rotation member, the connecting sleeve comprising a cylindrical support wall, the support seat comprising a mounting end adjacent to the connecting sleeve, and the support wall abutting the mounting end.

9. The support mechanism of claim 8, wherein a bottom of the support wall comprises a joint portion abutting the mounting end and a notch portion adjacent to the joint portion, and the notch portion and the mounting end cooperatively define a gap therebetween to enable the connecting sleeve to rotate relative to the support seat within a predetermined angle.

10. The support mechanism of claim 9, wherein the support seat and the connecting sleeve are made of extruded aluminum material.

11. A support mechanism, comprising:
a hinge assembly for being connected to a display panel;
a support seat axially defining a chamber, and comprising a plurality of substantially coplanar restricting portions at a top of a circumferential periphery of the chamber and a plurality of support portions at the circumferential periphery of the chamber below the restricting portions, the restricting portions and the support portions cooperatively defining an annular receiving space therebetween, the support seat further defining a lateral positioning hole communicating with the receiving space;
a positioning member receiving in the positioning hole; and
a mounting member connected to the hinge assembly and comprising a pisition portion at a circumference thereof, the position portion being received in the receiving space and comprising a position protrusion and a position groove, the position protrusion abutting one of the restricting portions and the position groove engagingly receiving the positioning member such that the hinge assembly is fixed to the support seat.

12. The support mechanism of claim 11, wherein each support portion comprises a support surface facing the restricting portion, and the support surface extends along a radial direction of the support seat.

13. The support mechanism of claim 11, wherein the positioning member is in the shape of an externally threaded cylinder and comprises a resisting end, and the resisting end extends into and is engaged in the position groove.

14. The support mechanism of claim 13, wherein the position portion defines a plurality of notches around a periphery thereof, the plurality of notches correspond to the plurality of restricting portions, and a length of each notch is greater than that of the corresponding restricting portion, such that an inner wall of each notch and the corresponding restricting portion cooperatively define a gap therebetween to enable the position portion to pass the restricting portions when inserted into the top of the support seat and reach the receiving space.

15. The support mechanism of claim 14, wherein the hinge comprises a bracket and a rotation member rotatably connected to the bracket, the bracket comprises a blocking portion, and the plurality of notches of the position portion comprise a long notch; and
when the position portion is rotated within the receiving space, the blocking portion is capable of resisting opposite ends of the long notch to restrict a rotation angle between the bracket and the mounting member.

16. The support mechanism of claim 15, wherein the bracket comprises a recess, the rotation member comprises a latching portion, and the latching portion is slidably engaged in the recess and capable of resisting opposite end surfaces of the recess to restrict a rotation angle between the rotation member and the bracket.

17. The support mechanism of claim 16, further comprising a connecting sleeve sleeved on the hinge assembly and connected to the rotation member, the connecting sleeve comprising a support wall, the support seat comprising a mounting end, and the support wall abutting the mounting end.

18. The support mechanism of claim 17, wherein the support wall comprises a joint portion abutting the mounting end and defines a notch portion adjacent to the joint portion, and the notch portion and the mounting end cooperatively define a gap therebetween to enable the connecting sleeve to rotate relative to the support seat within a predetermined angle.

19. The support mechanism of claim 18, wherein the support seat and the connecting sleeve are made of extruded aluminum material.

20. A support mechanism, comprising:
a hinge assembly for being connected to a display panel;
a hollow support seat, an inner face of a circumferential wall of the support seat comprising a plurality of restricting portions aligned in a plane perpendicular to an axis of the support seat and an annular support portion below the restricting portions, the restricting portions and the support portion cooperatively defining a receiving space therebetween, one of the restricting portions defining a latching groove; and
a mounting member connected to the hinge assembly and comprising a peripheral position portion, a resilient latching member extending from at a top surface of the position portion adjacent to an edge of the position portion, the position portion being capable of passing the restricting portions when inserted into a top of the support seat and rotating within the receiving space to a predetermined position in which the latching member is engaged in the latching groove of the one of the restricting portions to fix the hinge assembly to the support seat.
